(19) United States
(12) Patent Application Publication
(10) Pub. No.: US 2013/0112294 A1
(43) Pub. Date: May 9, 2013

(54) HOT MELT TANK AND CHECK VALVE

(71) Applicant: Graco Minnesota Inc., Minneapolis, MN (US)

(72) Inventors: Daniel P. Ross, Maplewood, MN (US); Paul R. Quam, Minneapolis, MN (US)

(73) Assignee: GRACO MINNESOTA INC., Minneapolis, MN (US)

(21) Appl. No.: 13/671,267

(22) Filed: Nov. 7, 2012

Related U.S. Application Data
(60) Provisional application No. 61/556,569, filed on Nov. 7, 2011.

(51) Int. Cl. F16L 55/00

(52) U.S. Cl. CPC F16L 55/00
USPC 137/511

(57) ABSTRACT

A hot melt dispensing system includes a hot melt tank having a tank outlet, a flow passage extending from the tank outlet, and a check valve. The flow passage has a first end and a second end. The first end is adjacent the tank outlet. The check valve is positioned at the first end of the flow passage.

### BACKGROUND

The present disclosure relates generally to systems for dispensing hot melt adhesive. More particularly, the present disclosure relates to melt systems for use in systems for dispensing hot melt adhesive.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

According to the present invention, a hot melt dispensing system includes a hot melt tank having a tank outlet, a flow passage extending from the tank outlet, and a check valve. The flow passage includes a valve socket at a first end adjacent the tank outlet and a pump receptacle at a second end. The check valve is positioned in the valve socket.

Another embodiment is a hot melt dispensing system including a hot melt tank having a tank outlet, a flow passage extending from the tank outlet, and a check valve. The flow passage has a first end and a second end. The first end is adjacent the tank outlet. The check valve is positioned at the first end of the flow passage.

Another embodiment is an apparatus including a hot melt tank with a tank outlet and a valve housing formed as a single piece unit with the hot melt tank. The valve housing defines a flow passage extending from the tank outlet with a valve socket formed in the flow passage at the tank outlet.

### BRIEF DESCRIPTION OF THE DRAWINGS

FIG. 1 is a schematic view of a system for dispensing hot melt adhesive.

FIG. 2 is a schematic side sectional view of one embodiment of a melt system and pump for use in the system of FIG. 1.

FIG. 3 is a schematic side sectional view of another embodiment of a melt system and pump for use in the system of FIG. 1.

### DETAILED DESCRIPTION

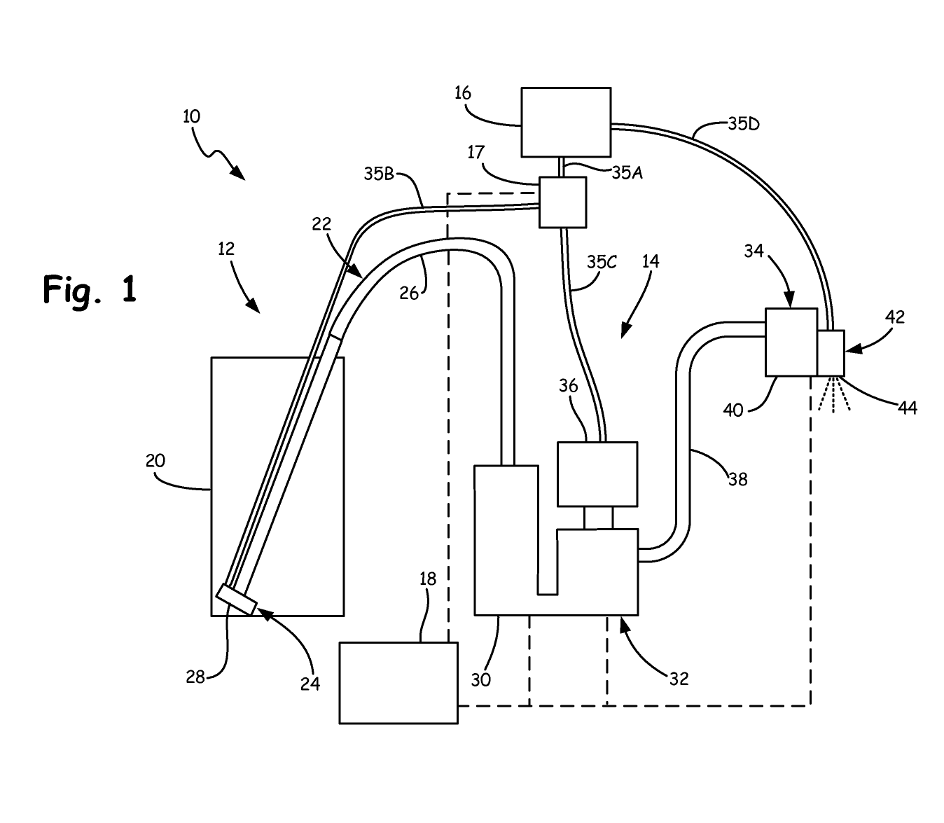

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

Solid adhesive pellets are delivered from feed hose 26 to melt system 30. Melt system 30 can include a container (not shown) and resistive heating elements (not shown) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30, through supply hose 38, to dispenser 34. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

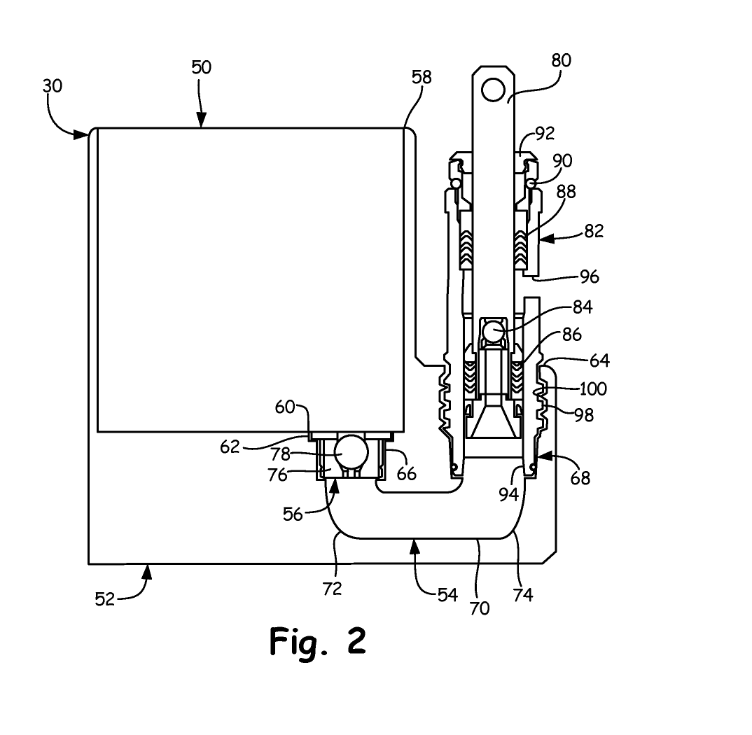

FIG. 2 is a schematic side sectional view of one embodiment of melt system 30 and pump 32 for use in system 10 of FIG. 1. Melt system 30 includes hot melt tank 50, valve housing 52 which defines flow passage 54, and check valve 56. Hot melt tank 50 can be formed as a single piece with valve housing 52. In the illustrated embodiment, hot melt tank 50 and valve housing 52 are cast as a single piece. Hot melt tank 50 and valve housing 52 can be machined as necessary after being formed together by casting. Hot melt tank 50 and valve housing 52 can be made of aluminum, steel, or another heat-conducting material suitable for the application.

Hot melt tank 50 includes tank inlet 58 at a top of hot melt tank 50 and tank outlet 60 at a bottom of hot melt tank 50. Hot melt tank 50 is a container for receiving adhesive pellets from feed assembly 22 (shown in FIG. 1) and is heated to melt those adhesive pellets into liquefied adhesive. One or more heaters (not shown) can be included for heating hot melt tank 50, such as a circular band heater positioned around hot melt tank 50 and/or one or more heating elements inserted into hot melt tank 50 and/or valve housing 52. In the illustrated embodiment, hot melt tank 50 defines a substantially cylindrical cavity for holding adhesive pellets and liquefied adhesive. In alternative embodiments, hot melt tank 50 can have an alternative configuration, such as having a plurality of chambers or passages that increase the surface area of hot melt tank 50.

Valve housing 52 is positioned below hot melt tank 50 and flow passage 54 extends below hot melt tank 50. Flow passage 54 has first end 62 adjacent tank outlet 60 and has second end 64. Flow passage 54 extends from tank outlet 60 such that second end 64 is distal from tank outlet 60. Valve housing 52 defines valve socket 66 at first end 62 and defines pump receptacle 68 at second end 64. Valve socket 66 is positioned below tank outlet 60. In the embodiment illustrated in FIG. 2, flow passage 54 includes straight section 70 between two elbow sections 72 and 74. Elbow section 72 connects straight section 70 to valve socket 66. Elbow section 74 connects straight section 70 to pump receptacle 68. Valve socket 66 and pump receptacle 68 are oriented substantially vertically and straight section 70 is oriented substantially horizontally.

Check valve 56 includes valve body 76 and valve ball 78 positioned in valve body 76. Check valve 56 can include a spring (not shown) biasing valve ball 76 in an open or a closed position. Check valve 56 can be positioned in valve housing 52 along flow passage 54. In the illustrated embodiment, check valve 56 is positioned at first end 62 adjacent tank outlet 60. Check valve 56 is positioned in valve socket 66, which can be sized and shaped to hold check valve 56 in place. Check valve 56 can be press fit in valve socket 66 or can be threaded in valve socket 66. Check valve 56 is a one way anti-siphon valve that allows liquefied adhesive to flow from hot melt tank 50 to pump 32 but that reduces or substantially prevents flow in an opposite direction.

Pump 32 includes pump shaft 80, pump cylinder 82, piston check valve 84, seals 86, 88, and 90, and throat cartridge 92. Pump shaft 80 is a piston that is movable within pump cylinder 82. Seals 86 and 88 are v-packing seals positioned between pump shaft 80 and pump cylinder 82. Seal 90 is a throat seal between throat cartridge 92 and pump cylinder 82. Throat cartridge 92 is attached at a top of pump cylinder 82 and extends circumferentially around pump shaft 80. Pump cylinder 82 includes pump inlet 94 at its bottom and pump outlet 96 on its side.

Pump receptacle 68 is a pump connection for connecting pump 32 to valve housing 52. In the illustrated embodiment, pump receptacle 68 is connected directly to pump 32, with pump 32 positioned partially inside pump receptacle 68. Pump cylinder 82 includes threaded outer surface 98, and pump receptacle 68 includes threaded inner surface 100. Threaded outer surface 98 is engaged with threaded inner surface 100 to attach pump 32 to pump receptacle 68. In alternative embodiments, pump 32 can be connected to pump receptacle 68 via other means suitable for the application.

Pump 32 pumps liquefied adhesive from hot melt tank 50 to dispenser 34 (shown in FIG. 1). Pump 32 is a single action pump that is activated via motor 36 (shown in FIG. 1) driving pump shaft 80. As pump shaft 80 is actuated in a first direction (upward as illustrated in FIG. 2), check valve 56 opens and piston check valve 84 closes so as to draw liquefied adhesive from hot melt tank 50, through check valve 56, through flow passage 54, and into pump 32. As pump shaft 80 is actuated in a second direction (downward as illustrated in FIG. 2), check valve 56 closes and piston check valve 84 opens so as to push liquefied adhesive from pump 32, through piston check valve 84, and out pump outlet 96. The reciprocating motion of pump shaft 80 can be repeated to continue to pump liquefied adhesive from pump 32 to dispenser 34. In alternative embodiments, pump 32 can be replaced with a different pump suitable for the application.

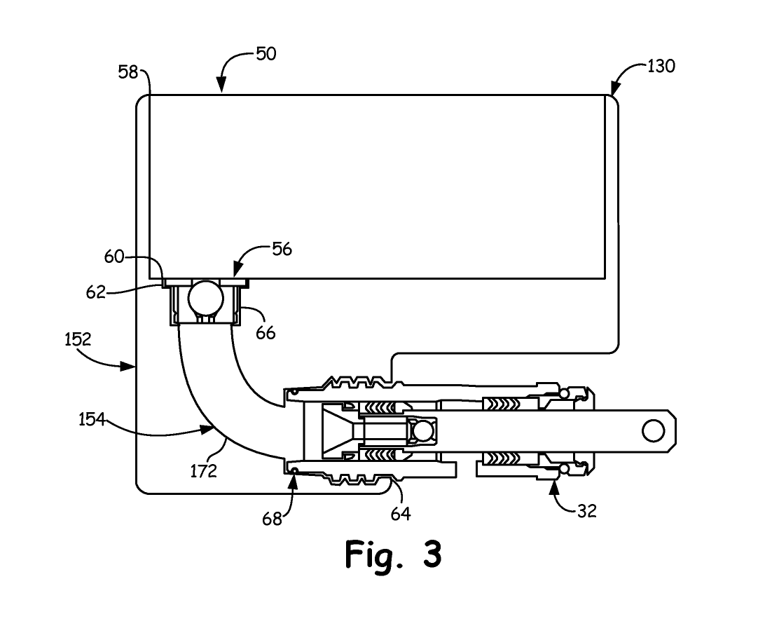

FIG. 3 is a schematic side sectional view of pump 32 and melt system 130, which is an alternative embodiment of melt system 30 (shown in FIGS. 1 and 2). Melt system 130 is similar to melt system 30 except that melt system 130 includes valve housing 152 which defines flow passage 154. In the illustrated embodiment, flow passage 154 has elbow section 172 connecting valve socket 66 at first end 62 to pump receptacle 68 at second end 64. Elbow section 172 is a substantially continuous curve between valve socket 66 and pump receptacle 68. Valve socket 66 is oriented substantially vertically and pump receptacle 68 is oriented substantially horizontally. Flow passage 154 has fewer turns than flow passage 54 (shown in FIG. 2) and can be shorter than flow passage 54.

By forming hot melt tank 50 as a single piece with valve housing 52 or 152, melt systems 30 and 130 can have a relatively small number of machined components. Because flow passages 54 and 154 can be relatively short, a relatively small amount of material can be wasted during flushing of liquefied adhesive. By including check valve 56 at tank outlet 60, another valve need not be included at pump inlet 94. Melt systems 30 and 130 can have a relatively small footprint, which can allow for a relatively small mass requiring heating and a correspondingly small energy consumption.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, various components of system 10 can be sized, shaped, and configured differently than as illustrated as appropriate for a given application.

1. A hot melt dispensing system comprising:
a hot melt tank having a tank outlet;
a flow passage extending from the tank outlet, the flow passage comprising:
a valve socket at a first end adjacent the tank outlet; and
a pump receptacle at a second end; and
a check valve positioned in the valve socket.

2. The hot melt dispensing system of claim 1, wherein the hot melt tank and the flow passage are a single piece unit.

3. The hot melt dispensing system of claim 1, wherein the pump receptacle has a threaded inner surface.

4. The hot melt dispensing system of claim 1, and further comprising:
a pump connected to the flow passage at the pump receptacle.

5. The hot melt dispensing system of claim 4, and further comprising:
a container for storing adhesive pellets;
a feed system for transporting adhesive pellets from the container to the hot melt tank; and
a dispenser connected to the pump for administering liquefied adhesive from the pump.

6. The hot melt dispensing system of claim 4, wherein the pump comprises:
a pump inlet;
a pump outlet;
a piston; and
a piston check valve connected to the piston and positioned fluidically between the pump inlet and the pump outlet.

7. The hot melt dispensing system of claim 3, wherein movement of the piston in a first direction draws liquefied adhesive from the hot melt tank to the pump when the check valve is open and the piston check valve is closed, and wherein movement of the piston in a second direction pushes liquefied adhesive from the pump out the pump outlet when the check valve is closed and the piston check valve is open.

8. The hot melt dispensing system of claim 1, wherein the pump receptacle and the valve socket are oriented substantially vertically, and wherein the flow passage further comprises:
a straight section oriented substantially horizontally connecting the pump receptacle to the valve socket.

9. A hot melt dispensing system comprising:
a hot melt tank having a tank outlet;
a flow passage extending from the tank outlet and having a first end and a second end, wherein the first end is adjacent the tank outlet; and
a check valve positioned at the first end of the flow passage.

10. The hot melt dispensing system of claim 9, wherein the hot melt tank and the flow passage are a cast a single piece unit.

11. The hot melt dispensing system of claim 9, wherein the check valve comprises a valve ball positioned in a valve body.

12. The hot melt dispensing system of claim 9, wherein the first end and the second end are oriented substantially vertically, and wherein the flow passage further comprises:
a straight section oriented substantially horizontally connecting the first end to the second end.

13. An apparatus comprising:
a hot melt tank having a tank outlet; and
a valve housing formed as a single piece unit with the hot melt tank, wherein the valve housing defines a flow passage extending from the tank outlet with a valve socket formed in the flow passage at the tank outlet.

14. The apparatus of claim 13, wherein the hot melt tank and the valve housing are cast as the single piece unit.

15. The apparatus of claim 13, and further comprising:
a check valve positioned in the valve socket.

16. The apparatus of claim 13, wherein the valve housing comprises a pump connection at an end of the flow passage.

17. The hot melt dispensing system of claim 14, wherein the valve socket is oriented substantially vertically and wherein the pump connection is oriented substantially horizontally.

18. The apparatus of claim 16, wherein the pump connection has a threaded inner surface, the apparatus further comprising:
a pump having a threaded outer surface threadedly engaged with the threaded inner surface.

19. The apparatus of claim 13, wherein the tank outlet is at a bottom of the hot melt tank and the valve socket is positioned below the tank outlet.

20. The apparatus of claim 13, wherein the valve housing is positioned below the hot melt tank and the flow passage extends below the hot melt tank.
